(19) United States
(12) Patent Application Publication
(10) Pub. No.: US 2010/0085307 A1
(43) Pub. Date: Apr. 8, 2010

(54) TOUCH CONTROL MOBILE PHONE AND ANTI-MISOPERATION METHOD FOR COMMUNICATION

(75) Inventor: Yuan-Chen Chang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/414,899

(22) Filed: Mar. 31, 2009

(30) Foreign Application Priority Data
Oct. 8, 2008 (CN) 200810304775.2

(51) Int. Cl. G09G 5/00; G06F 3/041

(52) U.S. Cl. 345/168; 455/566

(57) ABSTRACT

A touch control mobile phone includes a plurality of touch keys, an error-detecting region, an inductor positioned in the error-detecting region, an IC electronically connected to the error-detecting region, and a CPU electronically connected to the IC. The inductor is capable of detecting a nearby object. When the inductor detects the nearby object, the error-detecting region is triggered to send a signal to the IC, the IC transmits the signal to the CPU to execute an instruction corresponding to the signal such that the plurality of touch keys are locked.

### BACKGROUND

1. Technical Field

The present disclosure generally relates to a touch control mobile phone and an anti-misoperation method for communication.

2. Description of Related Art

With the development of wireless communication and information processing technology, intelligent mobile phones, such as touch control mobile phones, are now in widespread use. However, when a user using a touch control mobile phone to communicate, his/her face often inadvertently contacts the touch panel or touch keys, thus introducing a misoperation and some problems to the user.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a plane view of a first embodiment of a touch control mobile phone including an error-detecting region, an integrated circuit (IC) and a central processing unit (CPU).

FIG. 2 is a block diagram of the error-detecting region, the IC and the CPU.

FIG. 3 is a flowchart of an anti-misoperation method for communication used in the touch control mobile phone in FIG. 1.

FIG. 4 is a plane view of a second embodiment of a touch control mobile phone.

### DETAILED DESCRIPTION

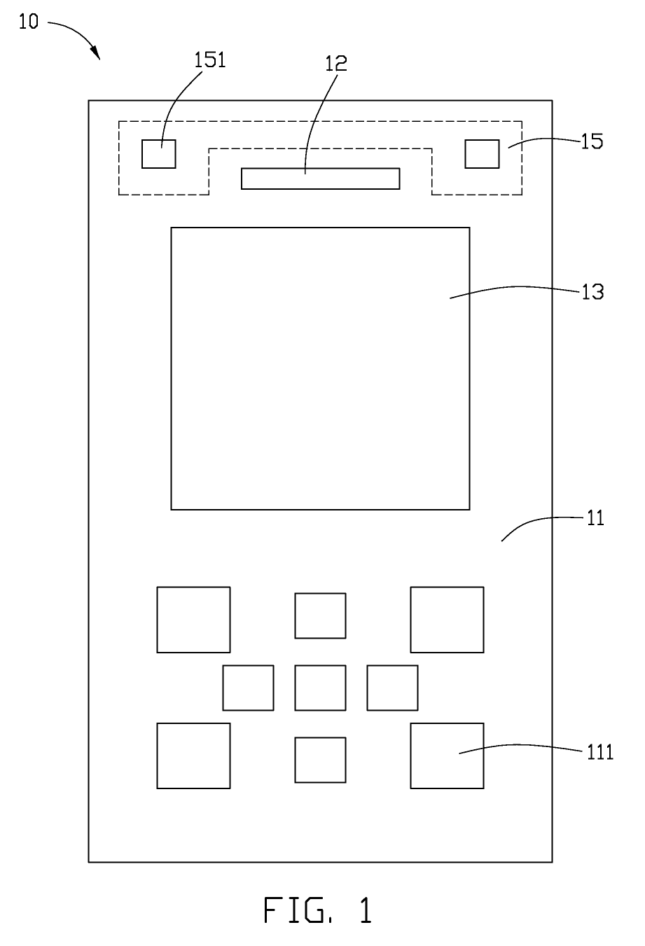

Referring to FIG. 1, a first exemplary embodiment of the touch control mobile phone 10 includes a touch key area 11, an earpiece 12, and a screen 13. The touch key area 11 is positioned below the screen 13, and includes a plurality of touch keys 111. The earpiece 12 is centrally positioned on top of the screen 13.

The touch control mobile phone 10 further includes an error-detecting region 15 positioned near the earpiece 12. The error-detecting region 15 may include two inductors 151 for detecting whether an object becomes adjacent to (but not in contact with) the error-detecting region 15 and then transmit signals according to the detection. The inductors 151 may be positioned on opposite sides of the earpiece 12. If just one of the inductors 151 detects the nearby object, a signal is not sent. If two inductors 151 simultaneously detect the nearby object, the error-detecting region 15 triggers the sending of a signal.

The inductors 151 may be capacitive, infrared, photoelectric, or ultrasonic. If the inductors 151 are capacitive, the changes of capacitance caused by the nearby object are detected. If the inductors 151 are infrared, the infrared light emitted from the nearby object is detected. If the inductors 151 are photoelectric, the changes of light intensity caused by the nearby object are detected. If the inductors 151 are ultrasonic, the changes of length of time those take for ultrasonic pulses to hit the nearby object and return as echoes are detected.

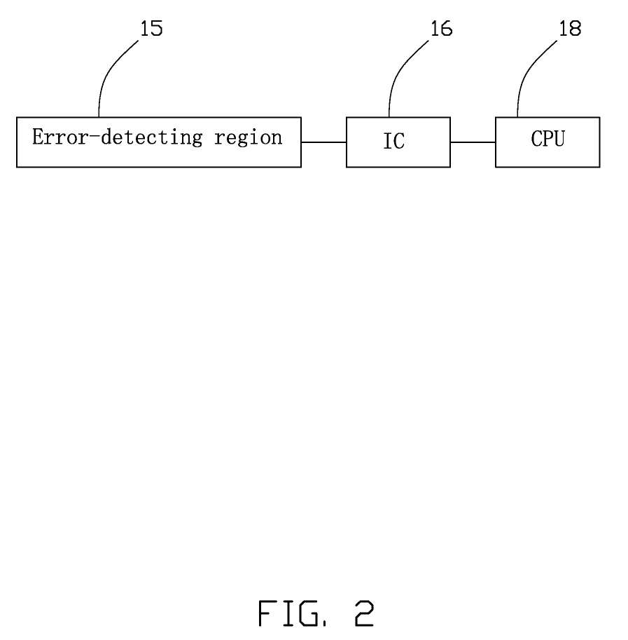

Referring to FIG. 2, the touch control mobile phone 10 further includes an IC 16 electronically connected to the error-detecting region 15, and a CPU 18 electronically connected to the IC 16. The IC 16 transmits the signal sent by the error-detecting region 15 to the CPU 18 to execute an instruction corresponding to the signal. When the error-detecting region 15 is triggered, the IC 16 transmits the signal sent by the error-detecting region 15 to the CPU 18. When the error-detecting region 15 is un-triggered, no signal is sent to the CPU 18.

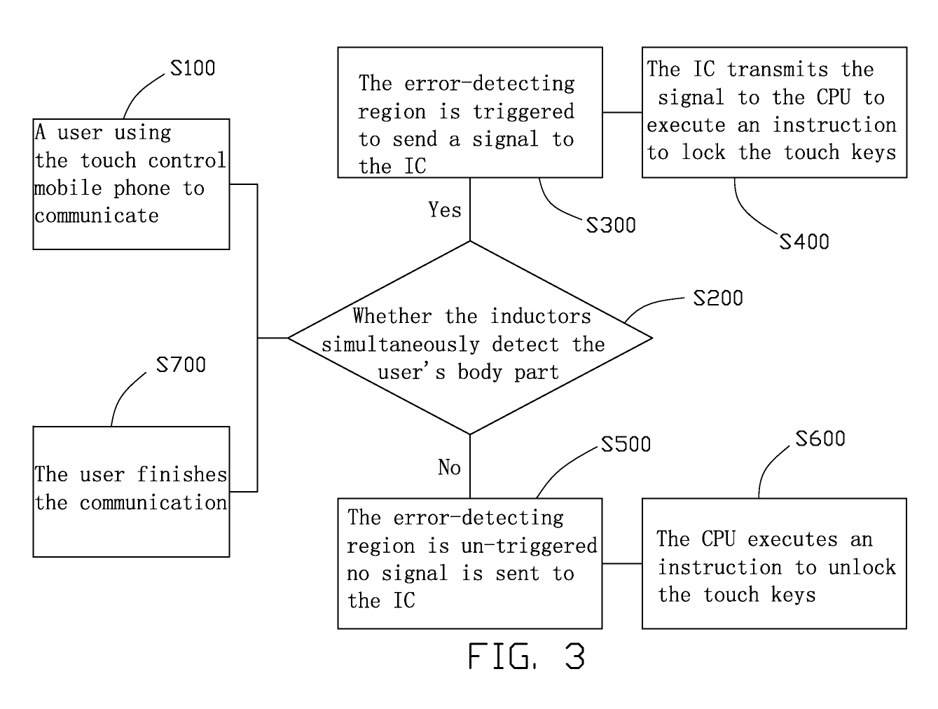

Referring to FIG. 3, an anti-misoperation method for communication used for the touch control mobile phone 10 is provided.

In step 100, a user using the touch control mobile phone 10 to communicate places a body part, such as face or ear close to the earpiece 12.

In step 200, whether the two inductors 151 simultaneously detect the user's body part is determined. If the two inductors 151 simultaneously detect the user's body part, the method continues to step S300. If the two inductors 151 do not simultaneously detect the user's body part, the method continues to step S500.

In step S300, the error-detecting region 15 is triggered to send a signal to the IC 16, then the method continues to step S400. In step S400, the IC 16 transmits the signal to the CPU 18 to execute an instruction to lock the touch keys 111. As a result, even if the touch keys 111 are inadvertently contacted by the user during the communication, the touch keys 111 are inoperative. Therefore, the probability of misoperation is decreased.

In step S500, the error-detecting region 15 is un-triggered and no signal is sent to the IC 16, then the method continues to step S600. In step S600, the CPU 18 can't receive the signal and thus executing an instruction to unlock the touch keys 111.

In step S700, the user finishes the communication and takes away the touch control mobile phone 10. Then the method continues to step S200, and repeats steps S300, S400 or S500, S600.

In this embodiment, the error-detecting region 15 is triggered when the two inductors 151 simultaneously detect the nearby object. Thus, if the user is in communication, the nearby area of the body part is large enough to be simultaneously detected by the two inductors 151, the touch keys 111 are locked. If the user is not in communication and just a finger comes inadvertently close to one of the inductors 151 during operation, the touch keys 111 are unlocked. Therefore, the two inductors 151 may accurately judge whether the user is indeed communicating and needs to lock the touch keys 111.

In alternative embodiments, there may be any number of inductors 151. The plurality of inductors 151 may be separately positioned on the error-detecting region 15. When at least half of the inductors 151 simultaneously detect the nearby object, the error-detecting region 15 triggers the sending of a signal. The touch key area 11 and the screen 13 may be integrated into a touch panel.

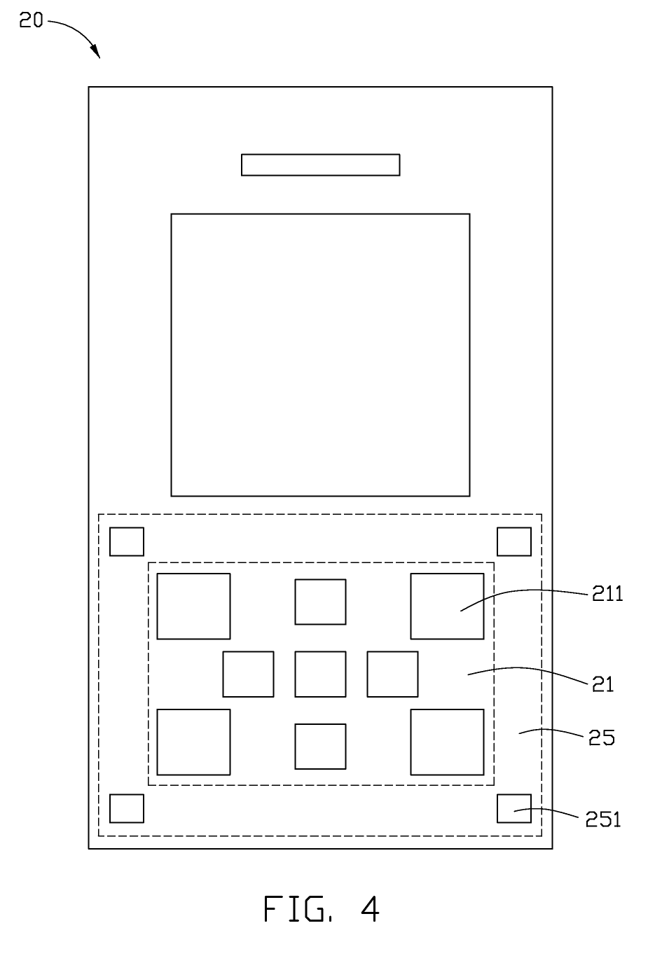

Referring to FIG. 4, a second embodiment of the touch control mobile phone 20 is shown. The touch control mobile phone 20 is similar in principle to the touch control mobile phone 10, except that an error-detecting region 25 is positioned around a touch key area 21. The error-detecting region 25 includes four inductors 251 positioned at four corners of the error-detecting region 25. When the four inductors 251 simultaneously detect a nearby object, the error-detecting region 25 is triggered to send a corresponding signal. In an alternative embodiment, there may be two inductors 251 positioned on a diagonal of the error-detecting region 25.

When the user using the touch control mobile phone 20 to communicate, a face of the user is simultaneously detected by four inductors 151, the error-detecting region 25 is triggered to send a signal to a CPU to lock a plurality of touch keys 211 in the touch key area 21, thereby preventing misoperation. When the user operates the touch control mobile phone 20, a probability of a finger is simultaneously detected by four inductors 251 is relatively low, so that the touch keys 211 may not be locked during the normal operation.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A touch control mobile phone, comprising:
a plurality of touch keys;
an error-detecting region;
at least one inductor positioned in the error-detecting region and capable of detecting a nearby object;
an IC electronically connected to the error-detecting region; and
a CPU electronically connected to the IC;
wherein when the at least one inductor detects the nearby object, the error-detecting region is triggered to send a signal to the IC, the IC transmits the signal to the CPU to execute an instruction corresponding to the signal such that the plurality of touch keys are locked.

2. The touch control mobile phone of claim 1, further comprising an earpiece, and the error-detecting region being positioned near the earpiece.

3. The touch control mobile phone of claim 2, wherein there are at least two inductors positioned on opposite sides of the earpiece; when the at least two inductors simultaneously detect the nearby object, the error-detecting region triggers the signal to the IC.

4. The touch control mobile phone of claim 2, wherein there is a plurality of inductors separately positioned on the error-detecting region; when at least half of the inductors simultaneously detect the nearby object, the error-detecting region triggers the signal to the IC.

5. The touch control mobile phone of claim 1, wherein the at least one inductor is selected from the group of the capacitive inductors, infrared inductors, photoelectric inductors, and ultrasonic inductors.

6. The touch control mobile phone of claim 1, wherein the error-detecting region is positioned around the touch key area.

7. The touch control mobile phone of claim 6, wherein there are at least four inductors positioned at four corners of the error-detecting region; when the at least four inductors simultaneously detect the nearby object, the error-detecting region triggers the signal to the IC.

8. The touch control mobile phone of claim 6, wherein there are at least two inductors positioned on a diagonal of the error-detecting region; when the at least two inductors simultaneously detect the nearby object, the error-detecting region triggers the signal to the IC.

9. The touch control mobile phone of claim 6, wherein there is a plurality of inductors separately positioned on the error-detecting region; when at least half of the inductors simultaneously detect the nearby object, the error-detecting region triggers the signal to the IC.

10. An anti-misoperation method for communication, comprising:
providing a touch control mobile phone having a plurality of touch keys;
setting an error-detecting region having at least one inductor to detect a nearby object;
setting an IC electronically connected to the error-detecting region, and a CPU electronically connected to the IC;
upon a condition that the at least one inductor detects the nearby object, the error-detecting region is triggered to send a signal to the IC, the IC transmits the signal to the CPU to execute an instruction to lock the plurality of touch keys;
upon a condition that the at least one inductor does not detect the nearby object, the error-detecting region is un-triggered and no signal is sent to the IC, the CPU can't receive the signal and thus executing an instruction to unlock the plurality of touch keys.

11. The anti-misoperation method of claim 10, wherein there are at least two inductors positioned on opposite sides of the earpiece; when the at least two inductors simultaneously detect the nearby object, the error-detecting region triggers the signal to the IC.

12. The anti-misoperation method of claim 10, wherein there is a plurality of inductors separately positioned on the error-detecting region; when at least half of the inductors simultaneously detect the nearby object, the error-detecting region triggers the signal to the IC.

13. The anti-misoperation method of claim 10, wherein the at least one inductor is selected from the group of the capacitive inductors, infrared inductors, photoelectric inductors, and ultrasonic inductors.
